(19) United States
(12) Patent Application Publication
(10) Pub. No.: US 2012/0199676 A1
(43) Pub. Date: Aug. 9, 2012

(54) Method for Separating and Recovering Concentrated Copper and Other Metal from Processed Recycled Materials

(76) Inventor: Thomas A. Valerio, New Port Richey, FL (US)

(21) Appl. No.: 13/310,553

(22) Filed: Dec. 2, 2011

Related U.S. Application Data
(60) Provisional application No. 61/419,409, filed on Dec. 3, 2010.

(51) Int. Cl. B02C 23/10; B02C 13/00; B07B 4/08

(52) U.S. Cl. 241/19; 241/24.25; 241/20

(57) ABSTRACT

Processing waste materials to recover valuable metals, such as copper, from the materials. The disclosed methods employ processes that further refine the waste materials to concentrate the metallic material after the waste materials are initially processed. Processes include employing mechanical separation, air separation, sizing, and density separation.

### RELATED APPLICATIONS

This non-provisional patent application claims priority under 35 U.S.C. §119 to U.S. Provisional Patent Application No. 61/419,409, entitled “Method and System for Separating and Recovering Concentrated Copper and Other Metal from Processed Recycled Materials,” filed Dec. 3, 2010, the complete disclosure of which is hereby fully incorporated herein by reference.

### FIELD OF THE INVENTION

This invention relates to systems and methods for recovering copper wire and other metals from recycled materials. More particularly, this invention relates to systems and methods for employing primarily dry processes for further recovering metals, typically after employing initial processes to separate materials in a recycle waste recovering operation.

### BACKGROUND OF THE INVENTION

Recycling of waste materials is highly desirable from many viewpoints, not the least of which are financial and ecological. Properly sorted recyclable materials can often be sold for significant revenue. Many of the more valuable recyclable materials do not biodegrade within a short period, and so their recycling significantly reduces the strain on local landfills and ultimately the environment.

Typically, waste streams are composed of a variety of types of waste materials. One such waste stream is generated from the recovery and recycling of automobiles or other large machinery and appliances. For examples, at the end of its useful life, an automobile is shredded. This shredded material is processed to recover ferrous and non-ferrous metals. The remaining materials, referred to as automobile shredder residue (ASR), which may still include ferrous and non-ferrous metals, including copper wire and other recyclable materials, is typically disposed of in a landfill. Recently, efforts have been made to further recover materials, such as non-ferrous metals including copper from copper wiring and plastics. Similar efforts have been made to recover materials from whitegood shredder residue (WSR), which are the waste materials left over after recovering ferrous metals from shredded machinery or large appliances. Other waste streams that have recoverable materials may include electronic components (also known as “e-waste” or “waste electrical and electronic equipment (WEEE)), building components, retrieved landfill material, or other industrial waste streams. However, in many instances, no cost-effective methods are available to effectively sort waste materials that contain diverse materials. This deficiency has been particularly true for non-ferrous materials, and particularly for non-metallic materials, such as non-ferrous metals, including copper wiring. For example, one approach to recycling wiring has been to station a number of laborers along a sorting line, each of whom manually sorts through shredded waste and manually selects the desired recyclables from the sorting line. This approach is not sustainable in most economics since the labor component is too high.

While some aspects of ferrous and non-ferrous recycling has been automated for some time, mainly through the use of magnets, eddy current separators, induction sensors and density separators, these techniques are ineffective for sorting some non-ferrous metals, such as copper wire. Again, labor-intensive manual processing has been employed to recover wiring and other non-ferrous metal materials. Because of the cost of labor, many of these manual processes are conducted in other countries and transporting the materials adds to the cost.

Many processes for identifying and separating materials are know in the art. For example, some processes are disclosed in U.S. Patent Application Publication 2007/0187299, entitled “Dissimilar materials sorting process, system and apparata,” and U.S. Patent Application Publication 2008/0257794, entitled “Method and system for sorting and processing recycled materials.” The entire content of these patent application publications are incorporated herein by reference. However, not all processes are efficient for recovering non-ferrous metals and the sequencing of these processes is one factor in developing a cost-effective recovery process. Also, many processes are “wet,” that is, they involve using water or other liquid media. Wet processes tend to be less cost effective, in part, because of the extra processing required to manage and dry materials and these processes often produce waste sludge that must be managed. Further, these processes may still provide a waste stream that can be further refined to provide a recovered product that has a high concentration of copper and other valuable metals.

In view of the foregoing, a need exists for cost-effective, efficient methods and systems for recovering materials from a waste stream, such as materials seen in a recycling process, including non-ferrous metals, in a manner that facilitates revenue recovery while also reducing landfill and where the process results in a high concentration of recovered metals, particularly copper from copper wire.

### SUMMARY OF THE INVENTION

The present invention provides cost-effective, efficient methods for recovering materials from a waste stream, such as materials seen in a recycling process, including non-ferrous metals, in a manner that facilitates revenue recovery while also reducing landfill and, using a process that results in a high concentration of recovered metals and particularly results in a high concentration of copper relative to other non-ferrous metals and other non-metal contaminants. In one exemplary aspect of the invention, a method for processing recycled materials is provided that includes the steps of: receiving a copper wire concentrate comprising one or more masses of tangled copper wire; processing the copper wire concentrate to break up the one or more masses of tangled copper wire; separating the copper wire into a first light fraction and a first heavy fraction using an air separator; reducing the size of the material in the first light fraction; and employing a density separator to separate the size reduced first light fraction into a second light fraction and a second heavy fraction.

### BRIEF DESCRIPTION OF THE DRAWINGS

FIG. 1 depicts a process flow diagram for processing recycled materials in accordance with an exemplary embodiment of the present invention.

### DETAILED DESCRIPTION OF EXEMPLARY EMBODIMENTS

Exemplary embodiments of the present invention described herein provide cost-effective, efficient methods for recovering materials from a waste stream, such as materials seen in a recycling process, including non-ferrous metals, in a manner that facilitates revenue recovery while also reducing landfill and, using a process that results in a high concentration of recovered metals and particularly results in a high concentration of copper relative to other non-ferrous metals and other non-metal contaminants.

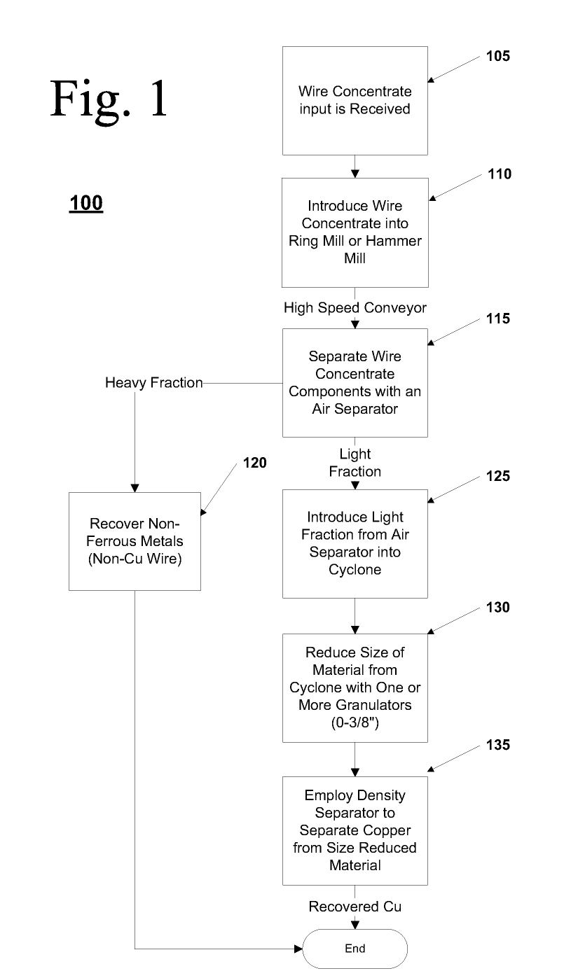

FIG. 1 depicts a process flow diagram 100 for processing recycled materials in accordance with an exemplary embodiment of the present invention. Referring to FIG. 1, at step 105, recycled material waste streams, or residues, such as ASR, WSR, and WEEE, are processed to separate and concentrate certain recoverable materials from the residues. Specifically, the process begins with a copper wire concentrate. A copper wire concentrate would include copper wire (both bare wire and wire including insulation) and other non-ferrous metals and other non-metal materials. This waste stream has been concentrated in these metals by removing ferrous metals and other non-metal materials from the ASR, WSR, and WEEE residues. While this initial processing will remove a large fraction of the ferrous metals, non-copper-non-ferrous metals, and non-metal materials, some of these materials may still be present in the copper wire concentrate. The process disclosed herein is applicable to copper wire concentrates with a wide range of percentages of copper wire.

Any combination of known or later-developed recycling processes can be used to generate a concentrate. One such resulting process stream is concentrated in copper and other, primarily non-ferrous, metals. One such system that may be used to generate a process stream of copper concentrate and other metals is an eddy current separator system. An eddy current separator typically includes a rotor featuring, on a cylinder surface, rows of permanent magnet blocks of alternate polarities. The permanent magnet blocks can either be standard ferrite ceramic or the more powerful rare earth magnets. The rotor spins at high revolutions, typically between 1800 rpm and 4000 rpm, to produce a variable magnetic field generating “eddy currents” in the metals crossing it. This eddy current reaction on the different non-ferrous metals is different based on their specific mass, shape, and resistivity, creating a repelling force on the charged particles of the non-ferrous metals and causing the materials to be separated.

Another system that may be used to generate a process stream of copper concentrate and other metals is an inductive sensor. An inductive sensor determines the presence of metal based on current produced in an inductive loop. The current from the inductive loop is filtered using two criteria: the amplitude (or magnitude) of the current and the time constant of the current. In other words, for an inductive sensor to indicate that a metallic object is present, the current generated in the inductive loop must reach a specified minimum level (threshold) and remain above that threshold for a specified time interval, called the debounce, before the digital output from the sensor is turned on. This digital output is an indication of the presence of a metallic object in the monitored material. The digital output is then held on until the inductive loop current drops back below the threshold.

Another system that may be used to generate a process stream of copper concentrate is a dynamic sensor system. A dynamic sensor differs from an inductive sensor. A dynamic sensor measures the rate of change of the amount of current produced in an inductive loop and detects the presence of metallic objects based on this rate of change. A key difference between a dynamic sensor and a standard inductive sensor is the way the detector filters and interprets the analog current level generated in the inductive loop. In an alternative embodiment, an inductive sensor (not shown) can be used instead of the dynamic sensor. Certain exemplary dynamic sensors are described in more detail in U.S. Pat. No. 7,732,726, entitled “System and Method for Sorting Dissimilar Materials Using a Dynamic Sensor,” issued Jun. 8, 2010, the complete disclosure of which is hereby fully incorporated herein by reference.

Eddy current, inductive sensor systems, and dynamic sensor systems are three exemplary systems that can be employed, perhaps in conjunction with other processes, to generate a process stream of copper concentrate and other metals. Other systems and processes may also be employed to generate a process stream of copper concentrate and other metals without deviating from the present invention. That is, the starting point for the present invention is a process stream of copper concentrate with still some other metals and some non-metal materials.

At step 110, the copper wire concentrate that entered the process at step 105 is introduced into a ring mill, hammer mill, or similar apparatus. The copper wire concentrate typically includes tangles of insulated wire with other non-ferrous metal pieces contained within the tangled masses. A primary purpose of step 110 is to break up the tangled masses of wire and non-ferrous metal pieces. The resulting waste form will include separated pieces of non-ferrous metals, copper wire, pieces of insulation, and other materials entrained in the tangled masses of copper wire concentrate. Another purpose of the ring mill or hammer mill is to break up large pieces of non-ferrous metals and non-metals which, in part, improves separation at step 110.

At step 115, the material processed by the ring mill or hammer mill is delivered to an air separator using a high speed conveyor belt (although other conveyor systems can be used). One possible air separator that may be used is a Zig-a-Flo Aspirator, manufactured by Forsberg, Inc. Another such air separator, modified for use with this type of material, is described in U.S. Patent Application Publication No. 2011/0067569A1, published Mar. 24, 2011 and entitled “Apparatus and Method for Separating Materials Using Air,” the complete disclosure of which is hereby fully incorporated herein by reference. Other air separators may be used, such as a “Z-box.”

This air separation step 115 results in two separated process streams. The light fraction stream will include copper wire. The heavy fraction will include other non-ferrous metals, such as aluminum, zinc, stainless steel, and brass. At step 120, these “heavy fraction” materials are collected from the “heavy fraction” outlet of the air separator. This fraction may be further processed to extract specific non-ferrous metals using conventional techniques.

At step 125, the light fraction is introduced into a cyclone. The cyclone serves to meter material into one or more granulators at step 130. The cyclone entrains the light fraction materials into an air stream as a means of moving the material to the granulator step 130. Typically, no additional separation of materials takes place at the cyclone. Other metering systems, such as a hopper, could alternatively be employed.

At step 130, the copper wire is size reduced in one or more granulators or grinders. For example, multiple granulators may be used in series to reduce the size of the copper wire in a stepwise fashion, such as reducing the copper to 1 inch in size in a first granulator and then to ¼ inch in size in a second granulator. Typically, the desired size for the copper leaving step 130 is 0-⅜ inches.

At step 135, the copper is further separated from other materials using a density separator, such as processing the material in a destoner, also referred to as a vacuum pressure separator (VPS). The terms “destoner” and “vacuum pressure separator” or “VPS” are used interchangeably in this disclosure. A destoner separates dry, granular materials into two specific weight fractions—a heavy fraction and a light fraction. Typically, a destoner includes a screen on a deck. Material is vibrated on the deck as air moves up through the screen. The light fraction is entrained in the air stream while the heavy fraction is not. A representative destoner is the Forsberg P-Series Destoner, made by Forsberg, Inc.

The light fraction separated by the destoner would typically include dirt, rocks, glass, plastic, rubber, and other materials with a density of less than approximately 2.8 grams per cubic centimeter. These materials are not worth recovering and, as such, this light fraction is not further processed. The heavy fraction separated by the destoner contains concentrated copper in the form of fine copper wire. This material is recovered and the process 100 ends.

While the VPS or destoner is one exemplary method for concentrating the copper, other methods can be used. One such method is similar to a VPS, but employs water as the transport medium instead of air, in a water separation or gravity concentration table. This table is pitched so that water flows towards one corner of the table. The table also has ridges, or riffles, that catch heavier solid material entrained in the water. Water and light solid material moves over the ridges and off the table. The heavier solid material is caught in the ridges and washed down the table, in the direction of the pitch of the table. Additional water is also introduced to promote the washing of the heavier solid material down the ridges.

Essentially, water separation tables are flowing film concentrators. Flowing film concentrators have a thin layer of water flowing across them, where these layers of water include entrained solid materials, materials with different densities. The film of water has varying velocities based on the distance from the water's surface. The highest velocity is the layer of water just below the surface of the water, and the lowest velocity layer, next to the deck surface of the table, is not moving at all. In between these layers the water moves at differing velocities, based upon the distance from the water's surface.

On a table, with particles of mixed densities, layers of material form, a particle in suspension will be subjected to a greater force the nearer it is to the surface of the water, and will cause it to tumble over those at greater distances from the surface. The combination of the particles tumbling and sliding and the flowing stream with differing velocities, will cause the bed of solids to dilate, and will allow high specific gravity particles to find their way down through the bed of low specific gravity particles, and eventually the low specific gravity particles will work their way to the top, where they will be carried along by the swifter flowing water.

A pattern of raised ridges (riffles) across the length of the table causes the higher density particles to stay behind the ridge, since they are closest to the bottom of the flowing water film. These particles, which would include the copper wire pieces, follow the ridge down the slope to the discharge, with the residence time giving the water flowing across the ridge more time to remove any low specific gravity particles (debris) trapped in the high specific gravity particle bed behind the ridge of the table.

Since the water is flowing perpendicular to the ridges or riffles of the table, the low specific gravity material will be washed over the top of the ridges and off the tailings discharge side of the table. The ridges of the table may be staggered to promote movement of the heavier solid material to the lowest corner of the table. In other words, the ridges extend a shorter length at the top, where the material and water mixture is introduced, as compared to the bottom. This arrangement results in a high concentration of copper at the lowest corner of the table. The copper is caught in the ridges and moves down the ridges by the force of the water, which pushes it to the lowest corner. At this point, copper is collected and is in a form to be sold, as the insulating wire was removed in the resizing process. At the corner opposite this low corner, relatively copper-free water comes off the table at the tailings discharge point. Along the edge between these two corners, the copper fraction increases. As some point, this middle portion of discharge, that contains some copper mixed with other debris, may be collected and, possibly reintroduced to the table to recover more of the copper. Also, in addition to copper, other metal, mixed with the copper, may be recovered in this process.

Although specific embodiments of the invention have been described above in detail, the description is merely for purposes of illustration. It should be appreciated, therefore, that many aspects of the invention were described above by way of example only and are not intended as required or essential elements of the invention unless explicitly stated otherwise. Modifications of, and equivalent steps corresponding to, the disclosed aspects of the exemplary embodiments, in addition to those described above, can be made by a person of ordinary skill in the art, having the benefit of this disclosure, without departing from the spirit and scope of the invention defined in the following claims, the scope of which is to be accorded the broadest interpretation so as to encompass such modifications and equivalent structures.

What is claimed:

1. A method for processing a waste stream comprising the steps of:
receiving a copper wire concentrate comprising one or more masses of tangled copper wire;
processing the copper wire concentrate to break up the one or more masses of tangled copper wire;
separating the copper wire into a first light fraction and a first heavy fraction using an air separator;
reducing the size of the material in the first light fraction; and
employing a density separator to separate the size reduced first light fraction into a second light fraction and a second heavy fraction.

2. The method of claim 1 wherein the step of processing the copper wire concentrate to break up the one or more masses of tangled copper wire employs a ring mill.

3. The method of claim 1 wherein the step of processing the copper wire concentrate to break up the one or more masses of tangled copper wire employs a hammer mill.

4. The method of claim 1 wherein the step of employing a density separator to separate the size reduced first light fraction into a second light fraction and a second heavy fraction employs a destoner.

5. The method of claim 1 wherein the step of employing a density separator to separate the size reduced first light fraction into a second light fraction and a second heavy fraction employs a water table.

6. The method of claim 1 wherein the step of reducing the size of the material in the first light fraction employs a grinder.

7. The method of claim 1 wherein the step of reducing the size of the material in the first light fraction employs a granulator.

8. The method of claim 1 further comprising the step of collecting the first heavy fraction to further separate non-ferrous metals other than copper.

9. The method of claim 1 wherein the step of separating the copper wire into a first light fraction and a first heavy fraction using an air separator employs an air separator with a closed system that recirculates the air used in the separator.

10. The method of claim 1 wherein the copper wire concentrate is generated from one of automobile shredder residue, whitegoods shredder residue, or waste electrical and electronic equipment, or combination thereof
